(19) United States
(12) Patent Application Publication
(10) Pub. No.: US 2022/0080546 A1
(43) Pub. Date: Mar. 17, 2022

(54) MOUNTING DEVICE AND METHOD FOR AUTOMATED DRILLING OF HOLES IN BUILDING WALLS

(71) Applicant: Inventio AG, Hergiswil (CH)

(72) Inventors: Andrea Cambruzzi, Zürich (CH); Christian Studer, Kriens (CH); Eliza Olczyk, Luzern (CH); Oliver Simmonds, Luzern (CH); Philipp Zimmerli, Harkingen (CH)

(21) Appl. No.: 17/309,112

(22) PCT Filed: Nov. 12, 2019
(86) PCT No.: PCT/EP2019/081018

§ 371 Date: Apr. 26, 2021

(30) Foreign Application Priority Data
Nov. 27, 2018 (EP) 18208422.8

(51) Int. Cl. B23Q 17/24; B25J 9/16

(52) U.S. Cl. CPC B23Q 17/2457; B66B 19/00; B25J 9/1697; B23Q 17/249

(57) ABSTRACT

A mounting device and a method for the automated drilling of holes in building walls includes the mounting device having a drilling device with a drill, an optical detection device for detecting a digital image of at least a part of the drill, and a control device for controlling the drilling device and the optical detection device. The control device evaluates the digital image to assess a condition of the drill.

### FIELD

The invention relates to a mounting device for the automated drilling of holes in building walls having a drilling device with a drill and to a method for assessing a condition of a drill of a drilling device of a mounting device for the automated drilling of holes in building walls.

### BACKGROUND

WO 2016/066615 A2 describes a mounting device having a drilling robot, which can automatically drill holes in walls and ceilings of a building. The mounting device has a carriage with driven and steerable wheels on which the drilling robot is arranged. The mounting device can thus be moved in the respective building and positioned at a position required for drilling the holes.

WO 2017/016783 A1 describes an automated mounting device for carrying out installations in an elevator shaft of an elevator system. The mounting device has a drilling device having a drill which can automatically drill holes in the walls of the elevator shaft. A carrier component of the mounting device carrying the drilling device can be displaced within the elevator shaft. WO 2017/016783 A1 describes that, in order to detect a worn or defective drill, a feed during drilling and/or a time period for making a bore with a desired depth are monitored. When falling below a feed limit value and/or when exceeding a duration limit value, the drill used is recognized as being no longer in order.

A drill can have different defects that can negatively influence the drilling of holes in walls of a building. For example, a diameter of the drill can no longer be large enough, so that the diameter of the hole drilled with the drill is too small. Drills for drilling in concrete often have at their tip a so-called bit made of particularly resistant material, in particular hard metal. If parts of the bit have broken off or the bit has come loose completely, the drilling of a hole is also influenced negatively.

### SUMMARY

In contrast, the problem addressed by the invention in particular is that of proposing a mounting device and a method which allow for a reliable drilling of holes in walls of a building.

The mounting device according to the invention for the automated drilling of holes in building walls has a drilling device having a drill. According to the invention, the mounting device has an optical detection device for detecting a digital image of at least a part of the drill of the drilling device, and a control device for controlling the drilling device and the optical detection device. The control device is provided to evaluate the aforementioned digital image and, in doing so, to assess a condition of the drill.

In the method according to the invention for assessing a condition of a drill of a drilling device of a mounting device for the automated drilling of holes in building walls, a digital image of at least a part of the drill of the drilling device is detected by means of an optical detection device arranged on the mounting device. The drilling device and the optical detection device are controlled by a control device. The control device evaluates the aforementioned digital image and, in doing so, assesses a condition of the drill.

It is thus possible to assess the condition of a drill even before a hole is drilled with a drill that is no longer suitable. The drilling of a hole can thus be carried out very reliably.

The described embodiments relate equally to the mounting device according to the invention and the method according to the invention. In other words, features mentioned below, for example, with reference to the mounting device, can also be implemented as method steps, and vice versa.

The mounting device according to the invention can in particular be used for the at least partially automated installation of so-called shaft material in an elevator shaft of an elevator system. Shaft material refers to all components that are fastened to a shaft wall in an elevator shaft of the elevator system. These include, for example, so-called rail brackets or rail bracket parts, in particular rail bracket lower parts, by means of which guide rails of the elevator system are firmly secured on the shaft wall. In addition, shaft material can also be designed as fastening material for shaft doors, lighting or cabling. For this purpose, the mounting device has in particular a carrier component on which the drilling device is arranged. The carrier component and thus the drilling device can be displaced within the elevator shaft and thus drill holes in the shaft walls of the elevator shaft at different positions in the elevator shaft. The basic structure of the mounting device can be designed, for example, in accordance with a mounting device described in WO 2017/016782 A1.

The mounting device according to the invention can also be used for mountings and installations outside an elevator shaft of an elevator. For example, the mounting devices can be used to drill holes at various points in a building wall, by means of which cable ducts or ventilation pipes can be securely fastened. In order to be able to reach the different points, the mounting device can have, for example, drivable and steerable wheels.

The mounting device according to the invention is provided to be at the respective mounting location only during the installation or mounting to be carried out and to be brought to the next installation location after completion of the installation or mounting. The mounting device according to the invention can thus also be called a mobile mounting device.

In the present context, automated drilling of holes means that the drilling device for drilling the holes is controlled by a control device using specified rules. For this purpose, in particular a program is stored in the control device, in which the aforementioned rules are encoded. The automated drilling can be started, for example, by an operator or by another program.

In this context, a building wall is supposed to refer to a surface which delimits a room of a building on the inside or the building on the outside. A building wall can thus be designed, for example, as a vertically running wall, a floor, or a ceiling. In particular, the building wall is designed as a shaft wall of an elevator shaft of an elevator system. However, it is also possible that the building wall is designed as part of a bridge or other structure. The building wall consists in particular of concrete which in particular contains reinforcements.

The drilling device is designed in particular as an impact drill which is particularly suitable for drilling in concrete. In particular, it is guided by a mechatronic installation component in the form of an industrial robot. The installation component can thus guide the drilling device when drilling a hole in a building wall and also position it in front of the optical detection device such that the optical detection device can detect a digital image of a relevant part of the drill or of the entire drill.

The drill is designed in particular as a spiral drill in the form of a stone or concrete drill. At its tip, the drill has in particular a plate or a bit made of hard metal, which is connected via a soldered connection to the rest of the drill which is made, for example, of tool steel.

The optical detection device can be designed in a number of ways; it can detect different optical properties of the drill and store them in a digital image. In particular, it is designed as a digital camera that can also detect and record colors. For this purpose, a digital camera has in particular three different types of light sensors, namely light sensors for red, yellow, and blue light. These three basic colors can be combined to form all colors. It is also possible for the optical detection device to have only one or two different types of light sensors, wherein it has in particular light sensors for blue light. The optical detection device can, for example, also be designed as a scanner or a so-called spectrophotometer.

The configuration of the aforementioned digital image depends on the design of the optical detection device. The digital image can thus also be designed in various ways. It contains information about the optical properties of the drill in digital form, which can be evaluated with a control device.

The control device for controlling the drilling device and the optical detection device can be designed as a single control device. It is also possible that it consists of a plurality of control devices that control individual components of the mounting device and are in communication with one another. In addition to the drilling device and the optical detection device, the control device can in particular control further components, such as the aforementioned installation component in the form of an industrial robot or an immobilization component or a displacement component of the mounting device.

The control device is provided to evaluate the digital image and, in doing so, to assess a condition of the drill. This means that the control device is programmed such that it evaluates the digital image and, in doing so, assesses the condition of the drill. An assessment of the condition of the drill refers in particular to a distinction between an “okay” (OK) condition and a “not okay” (NOK) condition. In addition to the aforementioned conditions, there can be further conditions such as “okay with reservations.”

In particular, the control device is provided to repeat the assessment of the condition of the drill at regular or irregular intervals. For example, the assessment can be carried out after each drilling of a hole or after drilling a specified number of holes. In this case, the aforementioned number can depend on the last detected condition of the drill. For example, if wear on the drill has already been detected, the aforementioned number can be smaller than it would be if no wear had yet been detected. In addition, depending on the specified requirements, an assessment can also be carried out independently of the number of holes drilled since the last assessment.

The objective of assessing the condition of the drill is that of detecting a condition of the drill, which is insufficient for a successful drilling, before drilling is started with such a drill. Drilling with a drill in an insufficient condition can lead to a poor drilling result, the drilling can take a very long time or, in the worst case, the drill can break. A breaking of the drill in the borehole very often requires intervention by an operator of the mounting device, so that automatic drilling of bores must be interrupted. Such an interruption is undesirable because it always takes up time.

In one embodiment of the invention, the control device is provided to decide on the basis of the recognized condition of the drill whether to continue using the drill or to initiate a change of the drill. The control device is provided in particular to continue using the drill if its condition is classified as OK and to initiate a change of the drill if its condition is classified as NOK. In this way, a particularly reliable drilling of holes in building walls can be ensured. In order to initiate a change of the drill, the control device can output information to an operator of the mounting device to change the drill. It is also possible that the mounting device has a second drilling device with a further drill and the change of the drill is carried out by using the aforementioned second drilling device. In addition, the mounting device can have an automated drill changing device, by means of which the old drill can be removed from the drilling device and a new drill inserted.

In one embodiment of the invention, the mounting device has a mechatronic installation component for guiding the drilling device. The mechatronic installation component is controlled by the control device and the control device is provided to control the installation component such that the drilling device and the drill are positioned in front of the optical detection device such that a digital image of at least a part of the drill can be detected and thus generated. The drilling device can thus be positioned very flexibly on the mounting device. In addition, the optical detection device can be arranged on the mounting device at a distance from the drilling device such that it does not obstruct the drilling of holes and is also not damaged or contaminated during drilling.

In one embodiment of the invention, the control device is provided to control the installation component such that the drilling device and the drill are positioned in front of the optical detection device such that a digital image of a wear mark arranged on the drill can be detected and thus generated. A particularly reliable determination of the condition of the drill is thus possible. The condition of the drill is classified as OK in particular if the wear mark can still be recognized in the digital image. For example, on an outer surface, in particular on an outer surface, the drill can have an inwardly directed groove as a wear mark at the tip of the drill. If material is removed from the aforementioned outer surface, i.e., if wear occurs, a depth of the groove decreases more and more until it can no longer be seen, i.e., it can no longer be recognized on the digital image.

In one embodiment of the invention, the aforementioned digital image contains information about a color of the drill. The control device is provided to check the color of the drill and to assess the condition of the drill on the basis of the results of the aforementioned check of the color of the drill. From the color of the drill, it can be deduced in particular whether the drill has become very hot during a previous drilling. In the event of excessive heating, the drill turns blue, which can be recognized by the control device. Excessive heating or overheating can lead to internal stresses building up in the drill and/or the material of the drill becoming brittle. Both effects can cause parts of the drill to break off or the drill to break apart. Excessive heating or overheating can have a further negative effect on drills with a soldered-on bit. The heating can be so great that the solder used to solder on the bit melts or at least becomes soft. This means that the risk of the bit breaking off is becoming very great. Even though the bit can still be correctly positioned at the tip of the drill, it can become detached during the subsequent heavy use which makes the drill unusable. The aforementioned effects can occur individually or they can enhance one another. In summary, excessive heating or overheating leads to an increased risk or the probability that a drill will soon fail with further use. The control device is thus designed in particular such that, when a color typical for overheating of the drill is detected in the digital image, it classifies the condition of the drill as NOK.

The control device is designed in particular such that it evaluates in particular the color in the region of the tip of the drill. In particular, it can carry out preprocessing in which contiguous regions of the drill with a similar color are identified. This can be carried out, for example, with a so-called blob analysis. In this case, a color can only be taken into account, for example, if it occurs on a contiguous surface or an overall surface with a minimum surface area.

When checking the color of the drill, the color can be compared with stored comparison colors. For example, as soon as the color matches a comparison color, the condition of the drill can be classified as NOK.

It is also possible to use pattern recognition processes or so-called machine learning to assess the condition of the drill. In this case, the control device is presented in a learning phase with a large number of digital images of drills together with the respective condition of the drill (OK or NOK). The control device can generalize the presented information, so that it can assess the condition of the drill in a productive phase on the basis of the knowledge learned and also on the basis of previously unknown digital images. Neuronal networks are one example of a machine learning method.

An optical detection device that can detect a digital image with a color of the drill, and a control device that is provided to check the color of the drill and to assess the condition of the drill on the basis of the results of the aforementioned check of the color of the drill, form an assessment device for assessing a condition of a drill of a drilling device. Such an assessment device represents a separate invention which can also be used independently of a mounting device.

In one embodiment of the invention, the control device is provided to determine a proportion of blue of the color of the drill and to assess the condition of the drill on the basis of the aforementioned proportion of blue. Drills turn in particular blue in case of excessive heating. The blue color of the drill is therefore a reliable indicator of strong, possibly excessive heating of the drill. As described above, excessive heating can lead to damage to the drill, which is not visible from the outside. The condition of the drill can thus be assessed particularly reliably by checking the proportion of blue of the drill. In particular, the condition of the drill is classified as NOK if the proportion of blue exceeds a specified threshold value.

A color can be divided into the three basic colors red, green, and blue on the basis of the teaching of additive color mixing. A color can thus be defined by the intensity of the proportions of the individual basic colors. In this case, the aforementioned proportion of blue of the color of the drill refers to the proportion of the blue basic color in the color of the drill. If only the proportion of blue of the color of the drill is to be used to assess the condition of the drill, the optical detection device can in particular only have light sensors that can detect blue light or be designed as a black-and-white digital camera with a filter that only lets blue light pass through.

In one embodiment of the invention, the aforementioned digital image contains information about an outer contour of the drill. The control device is provided to check the outer contour of the drill and to assess the condition of the drill on the basis of the results of the aforementioned check of the outer contour of the drill. As a result, mechanical damage to or wear on the drill can be detected easily and reliably. The outer contour of the drill or at least a part of the drill can be compared with a stored target outer contour. If the outer contour deviates too greatly from the target outer contour, the control device can classify the condition of the drill as NOK. In addition, as already described, machine learning methods can also be used.

In one embodiment of the invention, the control device is provided to detect parameters of a drilling process of the drilling device, to compare them with stored expectation parameters and, depending on the result of the comparison, to assess the condition of the drill used after the completion of the aforementioned drilling process and before the beginning of a subsequent drilling process. With the aforementioned comparison of the parameters of a drilling process with stored expectation parameters, it is possible to identify drilling processes in which the drill can potentially be damaged. As soon as such a drilling process is recognized, the condition of the drill is checked before the beginning of a subsequent drilling process. This can effectively prevent a drilling process from being carried out with a damaged drill.

In one embodiment of the invention, the control device is provided to detect a duration of the drilling process as a parameter of a drilling process, to compare it with an expectation parameter in the form of a limit duration and to assess the condition of the drill used after the completion of the aforementioned drilling process and before the beginning of a subsequent drilling process if the detected duration of the drilling process is greater than the limit duration. If a reinforcement in the form of a metal rod has to be drilled into or drilled through, in particular in a building wall made of concrete, the duration of the drilling process is significantly longer than it would be if no reinforcement is struck. The aforementioned limit duration can in particular be specified such that a drilling is safely completed without being impaired by a reinforcement. If a drilling process subsequently takes longer than the specified limit duration, it can be assumed with a high degree of probability that the drill struck a reinforcement. Drilling into or through a reinforcement leads to increased wear of the drill and, in particular, to excessive heating of the drill. This embodiment of the invention is particularly effective in preventing a drilling process from being carried out with a damaged drill.

In one embodiment of the invention, the control device is provided to detect a minimum feed speed of the drill during the drilling process as a parameter of a drilling process, to compare it with an expectation parameter in the form of a limit speed and to compare the condition of the drill used after completion of the aforementioned drilling process and before the beginning of a subsequent drilling process if the detected minimum feed speed during the drilling process is lower than the limit speed. If a reinforcement in the form of a metal rod has to be drilled into or drilled through, in particular in a building wall made of concrete, the minimum feed speed during the drilling process is significantly lower than it would be if no reinforcement is struck. The aforementioned limit speed can in particular be specified such that the minimum feed speed is safely higher without being impaired by a reinforcement. If the minimum feed speed is subsequently lower than the specified limit speed, it can be assumed with a high degree of probability that the drill struck a reinforcement. This embodiment of the invention is particularly effective in preventing a drilling process from being carried out with a damaged drill.

The drilling into or through a reinforcement can also be recognized in other ways. For example, the mounting device can have a reinforcement recognition component, by means of which reinforcements in a wall can be recognized.

In one embodiment of the invention, the mounting device has an automated drill changing device. The control device is provided to control the mounting device for a change of the drill of the drilling device such that a drill arranged in the drilling device is removed from the drilling device and a new drill is arranged in the drilling device. If the drilling device is guided by an installation component, the control device controls in particular the installation component such that the drill is removed from the drilling device and a new drill is arranged in the drilling device.

As a result of the thus-possible automated change of the drill, no manual intervention by an operator of the mounting device is possible for the change of the drill. The mounting device can thus drill a multiplicity of holes without manual intervention by an operator. The drilling of the holes can thus be carried out very quickly and efficiently.

The drill changing device can consist, for example, of a device for removing a tool from a tool holder and a magazine in accordance with the not pre-published European patent application by the applicant with application Ser. No. 18/186,467.9 (now WO 2020/025288 A1). In this case, the installation component is first controlled such that the drill is inserted into the aforementioned device for removal from the drilling device. After removal of the drill, the installation component is controlled such that a new drill from the magazine is arranged in the drilling device.

It must be noted that some of the possible features and advantages of the invention herein are described with reference to different embodiments of the mounting device according to the invention and the method according to the invention. A person skilled in the art recognizes that the features can be combined, adapted, transferred or exchanged in a suitable manner in order to arrive at further embodiments of the invention.

Further advantages, features and details of the invention will become apparent from the following description of embodiments and from the drawings in which identical or functionally identical elements are denoted with identical reference signs. The drawings are merely schematic and not to scale.

### DESCRIPTION OF THE DRAWINGS

In the drawings:

FIG. 1 is a perspective view of an elevator shaft of an elevator system with a mounting device according to the invention accommodated therein;

FIG. 2 is a perspective view of the mounting device from FIG. 1;

FIG. 3 shows a digital image of a part of a drill having a bit; and

FIG. 4 shows an enlarged depiction of the bit of the drill from FIG. 3.

### DETAILED DESCRIPTION

In the following, a mounting device and a method for the automated drilling of holes in building walls in connection with the installation of an elevator system in an elevator shaft will be described. However, the use of such a mounting device and such a method is not limited to the application described and can also be used for other purposes. For this purpose, adjustments to the mounting device and the method are required which a person skilled in the art can easily carry out with knowledge in the art and the remaining description.

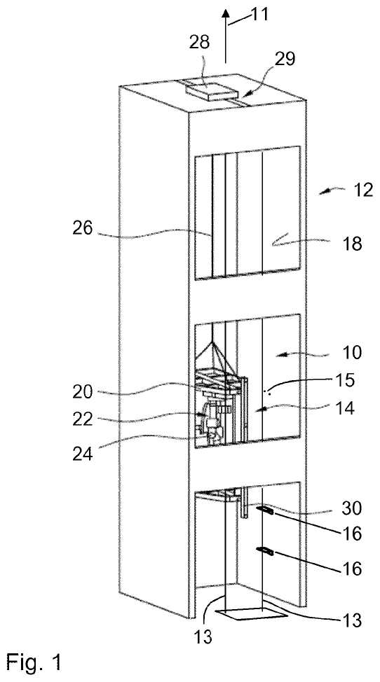

FIG. 1 shows a mounting device 14 arranged in an elevator shaft 10 of an elevator system 12, by means of which rail bracket lower parts 16 can be securely fastened to a building wall in the form of a shaft wall 18. For this purpose, holes 15 can be drilled into the shaft wall 18 by the mounting device 14. The elevator shaft 10 extends in a main extension direction 11 which is oriented vertically in FIG. 1. In a later mounting step, guide rails (not depicted) of the elevator system 12 can be securely fastened to the shaft wall 18 via the rail bracket lower parts 16. The mounting device 14 has a carrier component 20 and a mechatronic installation component 22. The carrier component 20 is designed as a frame on which the mechatronic installation component 22 is mounted. Said frame has dimensions that make it possible to vertically displace the carrier component 20 within the elevator shaft 10, i.e., for example, to move it to different vertical positions on different floors within a building. In the depicted example, the mechatronic installation component 22 is designed as an industrial robot 24 which is attached to the frame of the carrier component 20 so as to be suspended downwardly. In this case, one arm of the industrial robot 24 can be moved relative to the carrier component 20 and displaced, for example, toward the shaft wall 18 of the elevator shaft 10.

Via a steel cable used as a suspension means 26, the carrier component 20 is connected to a displacement component 28 in the form of a motor-driven cable winch that is attached at the top of the elevator shaft 10 to a retaining point 29 on the ceiling of the elevator shaft 10. By means of the displacement component 28, the mounting device 14 can be displaced within the elevator shaft 10 in the main extension direction 11 of the elevator shaft 10, i.e., vertically over the entire length of the elevator shaft 10.

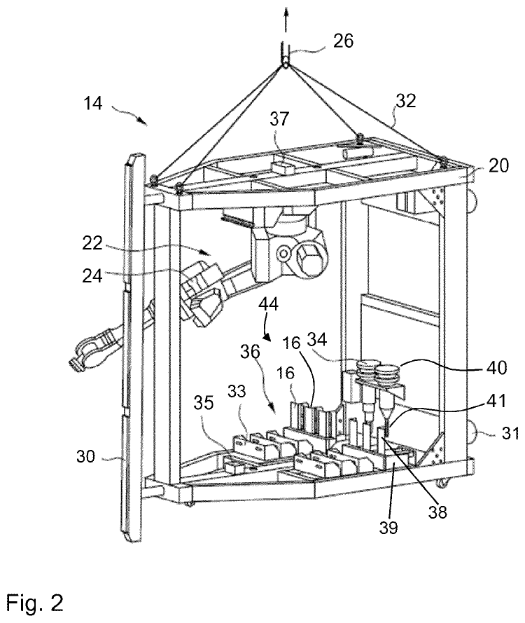

The mounting device 14 further comprises an immobilizing component 30 and support rollers 31 (FIG. 2), by means of which the carrier component 20 can be immobilized within the elevator shaft 10 in the lateral direction, i.e., in the horizontal direction.

Two reference elements 13 in the form of cords are tensioned in the elevator shaft 10 over the entire length thereof, which elements are oriented along the main extension direction 11. The reference elements 13 are attached in the elevator shaft 10 by an installer and provide the reference for orientation and mounting of guide rails of the elevator system 12. In the mounted state, the guide rails therefore need to run parallel to the reference elements 13 and at a specific distance from the reference elements 13. From the course of the reference elements 13, the course of the guide rails and thus the target positions of the rail bracket lower parts 16 on the shaft wall 18 can be inferred. The target positions of the holes 15 in the shaft wall 18 result from the target positions of the rail bracket lower parts 16.

FIG. 2 is an enlarged view of a mounting device 14.

The carrier component 20 is designed as a cage-like frame in which a plurality of horizontally and vertically running bars form a mechanically resistant structure. Retaining cables 32 are attached to the top of the cage-like carrier component 20, which cables can be connected to the suspension means 26.

In the depicted embodiment, the mechatronic installation component 22 is formed using an industrial robot 24. In the depicted example, the industrial robot 24 is equipped with a plurality of robotic arms that are pivotable about pivot axes. For example, the industrial robot can have at least six degrees of freedom, i.e., a mounting tool 34, 40 guided by the industrial robot 24 can be moved with six degrees of freedom, i.e., for example, with three degrees of rotational freedom and three degrees of translational freedom. For example, the industrial robot can be designed as a vertical buckling arm robot, as a horizontal buckling arm robot, or as a SCARA robot or a Cartesian robot, or as a portal robot.

The self-supporting or free end of the robot can be coupled to different mounting tools 34, 40. The mounting tools 34, 40 can differ with regard to their design and their intended use. The mounting tools 34, 40 can be held on the carrier component 20 such that the self-supporting end of the industrial robot 24 can be brought toward said tools and be coupled to one of them. For this purpose, the industrial robot 24 can have, for example, a tool changing system which is designed such that it allows at least for the handling of a plurality of such mounting tools 34, 40.

One of the mounting tools 34 is designed as a sensor, for example, as a laser scanner, by means of which the relative location of the carrier component 20 in relation to the reference elements 13 can be determined. This can be carried out, for example, using a method described in WO 2017/167719 A1. The position of the carrier component 20 in the elevator shaft 10 can be determined from the relative location of the carrier component 20 in relation to the reference elements 13. Based on the position of the carrier component 20, it can be determined at which points of the shaft wall 18 a rail bracket lower part 16 is to be fastened. In this way, the target position of a rail bracket lower part 16 on the shaft wall 18 and the target positions of the corresponding holes 15 can be determined.

One of the mounting tools 34 is designed as a reinforcement detection component. The reinforcement detection component is designed to detect a reinforcement within the shaft wall 18. For this purpose, the reinforcement detection component can use, for example, physical measurement methods in which electrical and/or magnetic properties of the typically metallic reinforcement within a concrete wall are used to identify said reinforcement in a positionally accurate manner.

One of the mounting tools is designed as a drilling device 40 having a drill 41 similar to an impact drill. By coupling the industrial robot 24 to such a drilling device 40, the installation component 22 is designed such that it allows for a controlled drilling of holes 15 in an at least partially automated manner in one of the shaft walls 18 of the elevator shaft 10. For this purpose, the drilling device 40 can be moved and handled by the industrial robot 24 such that the drilling device with the drill 41 drills holes 15 at a specified drilling position in the shaft wall 18 of the elevator shaft 10, into which fastening means in the form of anchor bolts (not shown) for immobilizing rail bracket lower parts are subsequently driven.

A further mounting tool 34 is designed as a driving tool in order to drive, in an at least partially automated manner, anchor bolts from bins 33 into previously drilled boreholes in the shaft wall 18 of the elevator shaft 10.

A further mounting tool 34 is designed as a gripper in order to fasten, in an at least partially automated manner, a rail bracket lower part 16 to the shaft wall 18.

A magazine component 36 can also be provided on the carrier component 20. The magazine component 36 can be used to store rail bracket lower parts 16 to be installed and provide them to the installation component 22. The magazine component 36 can also store and provide anchor bolts which can be driven into prefabricated boreholes in the shaft wall 18 by means of the installation component 22.

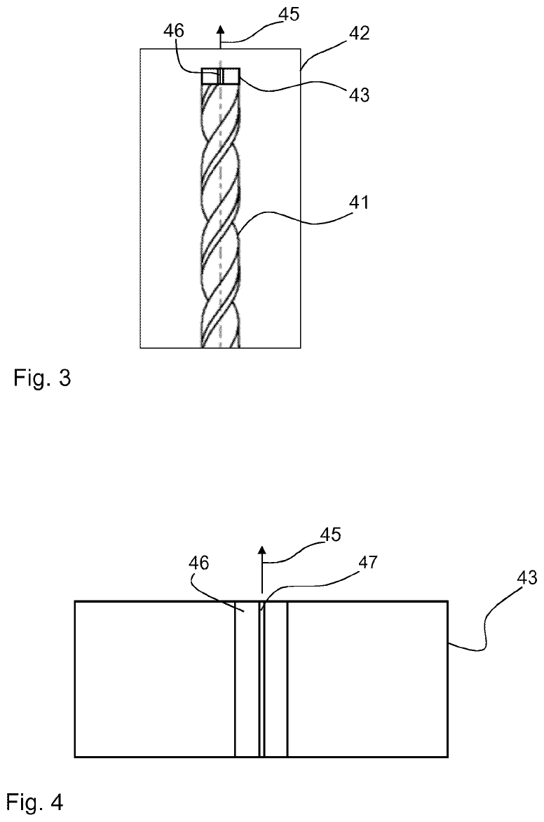

An optical detection device in the form of a digital camera 35 is arranged in the lower region of the carrier component 20. The digital camera 35 is positioned such that the drilling device 40 and thus the drill 41 can be positioned in front of the digital camera 35 by means of the industrial robot 24 such that the digital camera 35 can detect a digital image (42 in FIG. 3) of at least a part of the drill 41. In particular, the drill 41 is positioned in several different positions in front of the digital camera 35, so that the digital camera 35 can detect a plurality of digital images of different parts of the drill 41 and/or from different viewing angles. FIG. 3 shows, by way of example, a digital image 42 of the front region of the drill 41. At its tip, the drill 41 has a bit 43 made of hard metal which is connected to the rest of the drill via a solder connection (not depicted).

In the upper region of the carrier component 20, a control device 37 is arranged for controlling the mounting device 14 and thus, among other things, for controlling the industrial robot 24, the drilling device 40, and the digital camera 35. The control device 37 is in signal connection with the aforementioned components via signal lines (not depicted). The control device 37 evaluates the digital image of the drill 41 detected by the digital camera 35 and, in doing so, assesses a condition of the drill 41.

The control device 37 is programmed such that it distinguishes between two conditions, namely the “okay” (OK) condition and the “not okay” (NOK) condition, on the basis of the one digital image 42 or the plurality of digital images 42. In the following, the evaluation of a single digital image 42 will be addressed. If a plurality of digital images is evaluated, the OK condition of the drill 41 is only recognized if the OK condition results from the evaluation of all digital images.

If the control device 37 assesses the condition of the drill 41 to be OK, the drill 41 continues to be used, i.e., further holes 15 are drilled with the drill 41. If the control device 37 assesses the condition of the drill 41 to be NOK, it initiates a change of the drill 41, which is carried out in particular automatically, i.e., without the involvement of an operator of the mounting device 14.

In order to make an automatic change of the drill 41 possible, the mounting device 14 has a drill changing device 44 which consists of a device 38 for removing a tool from a tool holder and a magazine 39. For this purpose, the magazine 39 provides new drills 41 (not depicted) which can be picked up by the drilling device 40 after the old drill 41 has been removed. The device 38 and the magazine 39 are designed in accordance with the not pre-published European patent application by the applicant with application Ser. No. 18/186,467.9 (now WO 2020/025288 A1). For changing a drill 41, the drilling device 40 with the drill 41 is first moved by the industrial robot 24 such that the drill 41 is inserted into the device 38 and thereby removed from the drilling device 40. The drilling device 40 is subsequently moved such that it picks up a new drill 41 from the magazine 39. With the new drill 41, the drilling of holes 15 in the shaft wall 18 can be continued.

The control device 37 repeats the assessment of the condition of the drill 41 at regular intervals. It repeats the assessment after drilling a specified number of holes, for example, after 8 holes.

Each time a hole 15 is drilled, the control device 37 detects a duration of the drilling process and compares the detected duration with a specified and stored limit duration. If the detected duration is longer than the aforementioned limit duration, it assesses the condition of the drill 41 before the beginning of a subsequent drilling process and replaces it if necessary.

In addition, each time a hole 15 is drilled, the control device detects a minimum feed speed of the drill 41 and compares the detected minimum feed speed with a specified and stored limit speed. If the detected minimum speed is slower than the limit speed, it assesses the condition of the drill 41 before the beginning of a subsequent drilling process and replaces it if necessary.

The digital image 42 contains information about a color of the drill 41, which cannot be depicted in FIG. 3. The control device 37 checks the color of the drill 41 and evaluates the condition of the drill 41 on the basis of the results of the aforementioned check. From the color of the drill 41, it can be deduced whether the drill 41 has become very hot during a previous drilling. In the event of excessive heating, the drill 41 turns blue, which is recognized by the control device 37. The control device 37 classifies the condition of the drill as NOK if it detects a color in the digital image 42 that is typical for an overheating of the drill 41.

The control device 37 mainly evaluates the color in the region of the tip of the drill 41. It can also carry out preprocessing in which contiguous regions of the drill 41 with a similar color are identified. This can be carried out, for example, with a so-called blob analysis. A color is only taken into account if it occurs on a contiguous surface or an overall surface with a specified and stored minimum surface area.

When checking the color of the drill 41, the control device 37 compares the color of the drill 41 with stored comparison colors that are typical for excessive heating of the drill 41. If the color of the drill 41 matches a comparison color, the condition of the drill is classified as NOK.

The control device 37 can also determine a proportion of blue of the color of the drill 41 and assess the condition of the drill 41 on the basis of the aforementioned proportion of blue. The control device 37 only classifies the condition of the drill 41 as NOK if the proportion of blue exceeds a specified and stored threshold value.

The digital image 42 also contains information about an outer contour of the drill 41. The control device 37 checks the outer contour of the drill 41 and assesses the condition of the drill 41 on the basis of the results of the aforementioned check of the outer contour of the drill 41. For this purpose, the control device 37 compares the outer contour of the drill 41 with a stored target outer contour. If the outer contour of the drill 41 deviates too greatly from the target outer contour, the control device 37 classifies the condition of the drill 41 as NOK.

As shown in FIG. 4, the bit 43 of the drill 41 has a wear mark in the form of an inwardly directed groove 47 running in an axial direction 45. The groove 47 is arranged on an outer surface of one of a total of four webs 46 of the bit 43, which are arranged at right angles to one another. The drill 41 is positioned in front of the digital camera 35 such that a digital image of the web 46 with the groove 47 can be detected. As long as the control device 37 recognizes the groove 47 in the digital image, it classifies the drill 41 as OK. If it can no longer recognize the groove 47 in the digital image, a wear on the outer contour of the bit 43 is therefore too great and a diameter of the bit 43 is thus too small to be able to continue using the drill 41. The control device 37 thus classifies the drill 41 as NOK as soon as it can no longer recognize the groove 47 in the digital image of the drill 41.

Finally, it must be noted that terms such as “having,” “comprising,” etc. do not preclude other elements or steps and terms such as “a” or “an” do not preclude a plurality. It must further be noted that features or steps that have been described with reference to one of the above embodiments can also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A mounting device for automated drilling of holes in building walls, the mounting device having a drilling device with a drill and comprising:
an optical detection device detecting a digital image of at least a part of the drill of the drilling device;
a control device controlling the drilling device and the optical detection device;
wherein the control device evaluates the detected digital image to assess a condition of the drill and control the drilling device; and
wherein the detected digital image contains information about a color of the drill, and wherein the control device checks the color information and assesses the condition of the drill based upon a result of the color information check.

16. The mounting device according to claim 15 wherein the control device controls the drilling device based upon the assessed condition of the drill either to continue using the drill to drill holes or to initiate a change of the drill.

17. The mounting device according to claim 15 including a mechatronic installation component for guiding the drilling device, wherein the mechatronic installation component is controlled by the control device such that the drilling device and the drill are positioned in front of the optical detection device for the detection of the digital image of at least a part of the drill.

18. The mounting device according to claim 17 wherein the control device controls the mechatronic installation component to position the drilling device and the drill in front of the optical detection device such that the detected digital image includes a wear mark arranged on the drill.

19. The mounting device according to claim 15 wherein the control device performs the check by determining a proportion of blue in the color information and assesses the condition of the drill based upon the proportion of blue.

20. The mounting device according to claim 15 wherein the detected digital image contains information about an outer contour of the drill, wherein the control device checks the outer contour information and assesses the condition of the drill based upon a result of the outer contour information check.

21. The mounting device according to claim 15 wherein the control device detects parameters of a drilling process of the drilling device, compares the detected parameters with stored expectation parameters, and based upon a result of the comparison assesses the condition of the drill after completion of the drilling process and before beginning a subsequent drilling process.

22. The mounting device according to claim 21 wherein the control device detects a duration of the drilling process as one of the parameters, compares the detected duration with a limit duration being one of the stored expectation parameters, and assesses the condition of the drill after the completion of the drilling process and before the beginning of the subsequent drilling process when the detected duration is greater than the limit duration.

23. The mounting device according to claim 21 wherein the control device detects a minimum feed speed of the drill during the drilling process as one of the parameters, compares the detected minimum feed speed with a limit speed being one of the stored expectation parameters, and assesses the condition of the drill after the completion of the drilling process and before the beginning of the subsequent drilling process when the detected minimum feed speed is lower than the limit speed.

24. The mounting device according to claim 15 including an automated drill changing device, wherein the control device controls the drilling device and the automated drill changing device to initiate a change of the drill based upon the assessed condition of the drill by removing the drill from the drilling device and arranging a new drill in the drilling device.

25. A method for assessing a condition of a drill of a drilling device of a mounting device for automated drilling of holes in building walls, the method comprising the steps of:
detecting a digital image of at least a part of the drill of the drilling device using an optical detection device arranged on the mounting device;
controlling the drilling device and the optical detection device using a control device; and
operating the control device to evaluate the detected digital image and assess a condition of the drill based upon the evaluation.

26. The method according to claim 25 wherein the detected digital image contains information about a color of the drill, and the control device checks the color information and assesses the condition of the drill based upon a result of the color information check.

27. The method according to claim 25 wherein the detected digital image contains information about an outer contour of the drill, and the control device checks the outer contour information and assesses the condition of the drill based upon a result of the outer contour information check.
